(19) United States
(12) Patent Application Publication
(10) Pub. No.: US 2011/0259006 A1
(43) Pub. Date: Oct. 27, 2011

(54) VERSATILE THERMAL SOLAR SYSTEM FOR PRODUCING HOT WATER UP TO HIGH TEMPERATURES

(76) Inventor: Francisco Javier CUMPLIDO MATESANZ, Logrono (La Rioja) (ES)

(21) Appl. No.: 13/096,103

(22) Filed: Apr. 28, 2011

Related U.S. Application Data
(63) Continuation of application No. PCT/ES2009/070118, filed on Apr. 27, 2009.

(30) Foreign Application Priority Data
Oct. 30, 2008 (ES) U200803094

(51) Int. Cl. F03G 6/00; F24J 2/04

(52) U.S. Cl. 60/641.8; 126/646

(57) ABSTRACT

The present invention refers to a versatile thermal solar system for producing hot water up to high temperatures.

Thermal solar installation, comprising a battery (1) of two or more flat or vacuum-tube solar collectors (2), heat-transfer-fluid circulation pump (4), valve system (3) and control system (6), characterized by its wide operating range in terms of available temperature of the heat-transfer fluid (from +40° C. to +150° C.), also ensuring a constant flow of heat-transfer fluid, a constant temperature, or both parameters simultaneously. The control system (6) will act on the valve system (3), as well as on the speed of the circulation pump (4) to provide control over said parameters. All the components of the installation shall comply with the standards required to withstand temperatures up to 180° C.

### OBJECT OF THE INVENTION

The present invention, as expressed in the statement of the present specification, is intended to take advantage of solar thermal energy generated in a conventional installation by a regulation system able to achieving heating up water or other fluids in a range of both medium and high temperatures.

### TECHNICAL FIELD OF THE INVENTION

The present invention is part of the renewable energy sector, particularly in the use of solar thermal energy for hot water generation in industrial installations, heating installations, absorption chilling and domestic hot water.

### STATE OF THE ART

The Technical Building Code, in section HE4 of HE Basic Document, defines a thermal solar installation as one constituted by a set of components responsible for capturing solar radiation, transform it into thermal energy directly transferring it to a working fluid and, finally, storing said thermal energy efficiently, either in the same working fluid of the collectors, or transferring it to another one, to be able to use it later in the consumption points. Said system is complemented by a thermal energy production by an auxiliary standard system which may or may not be integrated into the same installation.

A conventional thermal solar installation comprises the following elements:
A collection system consisting of a battery of solar collectors, which can have a variable arrangement, associated to a piping system forming as a whole a circuit called primary. A primary fluid circulates inside the pipes and collectors, said fluid being usually water with the addition of antifreeze, which will be in charge of capturing the energy that the solar collectors have absorbed. For best performance of the installation, the solar collectors are coated with selective materials that allow the passage of radiation in one direction but not in the opposite direction.
An accumulation system consisting of one or more energy accumulation tanks. It stores the energy captured from solar radiation for use in the consumption circuit and allows the use of energy in a different time from its acquisition.
An exchange system, wherein energy from the accumulation system is transferred to a secondary fluid, which can be used directly at points of consumption or can be stored as hot fluid for energy storage.
A consumption system, consisting of all the points of consumption of the installation which, together with the exchange system, make up a second circuit called secondary circuit.
A regulation and control system, through which the functioning of the entire system is regulated, setting some setpoint parameters that will indicate the limits of proper operation, of both the primary and secondary circuit.
An auxiliary power system to supply energy in times when energy from the solar circuit is not sufficient to meet the needs at the points of consumption.
A fluid pumping system, which is responsible for causing forced circulation of fluid (both in the primary and in the secondary circuit) that runs through the pipes. Said pumping system can be removed in cases of natural convection circulation, where it takes advantage of the elevation difference existing between the various elements of the installation.
A security system to avoid excessive overheating of the solar system.

The energy captured from the solar system, will be transmitted to the secondary fluid thus generating hot water. According to the European standard UNE-EN 12828 on heating systems in buildings and design of water heating systems, which also applies to DHW systems (domestic hot water), it is prohibited to reach in the primary circuit temperatures in the primary fluid higher than 105° C., for the problems described, whereby the innovation introduced by the present invention opens the field of utilizing solar thermal installations, in a range of operating temperatures of +40° C. to +150° C., with absolute control of fluid temperature, flow rate, or both parameters simultaneously, ensuring continuity of said parameters in the temperature ranges indicated above. The invention is best applied in industrial installations requiring hot water at high temperature, and its main application is the production of absorption chilling, among others. However, considering the safety that the present invention has, it would be perfectly valid and safe for use in DHW installations (domestic hot water), heating, air conditioning or other applications.

The primary fluid, which has transferred all or part of its energy to the secondary fluid in the heat exchanger, returns to the field of collectors, where it will be heated again. Similarly, the secondary fluid, which has transferred energy at the points of consumption, returns to the heat exchanger where it is heated by the presence of hot primary fluid.

Examples of standard solar thermal installations are described in patent documents Nos. ES497078 and ES2156837, among others. Said inventions, do not deal with the temperatures to which said installations can work, or the available flow rates.

An important factor to be considered in solar thermal installations is the need for having a security system that acts as a protection against the overheating of the system and risk of freezing.

For protection against risk of freezing, water mixed with antifreeze is often used, so that the resulting mixture has a specific heat higher than 3 kJ/kgK at 5° C. below the historic minimum temperature recorded in the area where the installation is located.

For protection against overheating of the system, the installation shall be provided with manual or automatic safety devices that prevent overheating of the installation that can damage materials and equipment or penalize the quality of energy supply. Examples of these devices are an appropriate system of expansion and an outside drainage system of the overheated fluid.

Patent ES2272171 proposes a novel security system for solar thermal installations intended for production of water for heating or domestic hot water, which prevents that the primary fluid exceeds the limit value of 105° C. Similarly, patents ES2224844 and ES2272174 describe a heat energy sink system in solar installations.

Another important aspect covered in solar thermal installations is the need in many applications to reach a high operating temperature, around 100° C. or higher. Analyzing the current state of the art, to achieve said temperatures in the heat-transfer fluid in the primary circuit, the vast majority of the developed technology focuses on developing systems to capture solar energy by means of solar energy concentrator systems, or other special manufacturing solar collectors. One example is described in patent CN1461927, in which a solar installation is developed by using a collectors system of special manufacturing, which ensures quick reach of high operating temperatures. In the patent document ES2035990 reference is made to a solar collector for the generation of high temperatures.

In other cases, as described in patent U.S. Pat. No. 4,021,895, special installations are developed. In said invention, different batteries or groups of collectors are arranged, each of which work at different working temperatures, delivering the heat-transfer fluid heated to various storage tanks or to the same stratified tank. To do this, collectors of special features are needed at each battery.

It would therefore be desirable for solar thermal installations to be equipped with a system that would allow them to generate the water at high temperatures (above 100° C.), without the need of using special collectors or solar concentrators in large fields, being also installations versatile enough to generate water at a lower temperature without the need for changes of materials in the original installation. With our system of regulation and control that acts on those parts of the system affecting the arrangement of the batteries or solar collectors groups or the amount of heat-transfer fluid flowing through said batteries.

Patent documents JP56068753, U.S. Pat. No. 4,474,169, JP57157958, DE102005008646, among others, describe inventions of solar installations reaching a high operating temperature, without specifying the range of possible working temperatures. All these inventions are based on the use of a suitable valve system, which allows changing the configuration of the battery of collectors, arranging them in series, when wanting to raise the temperature of the heat-transfer fluid, or in parallel, when maintaining or reducing the temperature is desired. With this system temperature at the outlet of the battery of collectors can be regulated, but not maintaining a constant flow in the solar installation. In addition, possible variations of temperature at the outlet of the battery of collectors may be high. Another feature to be highlighted in the present inventions is the absence of information about the solar collectors required in them, not indicating whether special solar collectors are needed or if those currently existing in the market are valid.

Other inventions, as described in patent documents U.S. Pat. No. 4,257,395 and U.S. Pat. No. 4,130,110, allow regulating the temperature of the heat-transfer fluid through a system of regulation and control acting on the engine of the circulation pump of the primary circuit to vary the flow rate passing through said circuit. Although it is possible to adjust the temperature, the flow rate is not constant.

The state of the art previously mentioned, shows solar thermal installations which do not allow ensuring proper operation at high temperatures. Also, a constant flow rate or constant operating temperatures or both parameters simultaneously are not ensured.

The present invention, by a suitable control and regulation system provides an installation for solar thermal energy with such versatility that allows the generation of water or other fluids in a wide range of temperatures (from +40° C. to +150° C.). This is achieved safely, without using special collectors or solar concentrators, from a minimum of two units onwards. This versatility is achieved by keeping a constant input of heat-transfer fluid to the secondary circuit with regard to temperature, flow rate, or both parameters simultaneously.

### DESCRIPTION OF THE INVENTION

The present invention solves the problems and limitations present in the state of the art as noted above. To do this, it makes some necessary changes in configuration and arrangement of elements existing in a thermal solar installation, achieving a great versatility in operation. It obtains a heat-transfer fluid at the required temperature in the consumption circuit, if it is about both mean temperatures (+40, +80° C.) and high temperatures (greater than +80° C. to +150° C.), achieving in the primary circuit, circuit through which the heat-transfer fluid flows, stable and continuous conditions in terms of temperature, flow rate, or both parameters simultaneously. Also, it does it with a total control of all parameters.

The invention is advantageously applicable to any use that requires heat energy in a wide range of working temperatures (from +40° C. to +150° C.). These installations may be implemented by companies that have said technology. Overheating in the installation that can be a problem for it, as it currently happens, is prevented, being able to work at the same time at lower and more usual temperatures.

The system works at low and high temperatures (from +40° C. to +150° C.) in a stable and automatic manner, which opens a new and vast field of solar energy utilization.

In current solar thermal installations disadvantages and problems appear when high temperatures are reached in the primary circuit (over 100° C.). Indeed, in many cases, solar thermal installations currently existing are protected in order to avoid achieving this high temperature range. That is, its design provides security systems that avoid temperatures higher than 105° C.

It is intended to develop a solar thermal installation adapted to work properly at low and high temperatures, according to the required temperature in the secondary or consumption fluid, maximizing the energy input throughout the year, for its use in industrial installations, being of great use to produce hot water, water for heating, air conditioning or absorption chilling installations, etc.

The current state of the art provides solar thermal installations that reach high temperatures in the primary fluid, wherein the installation of solar energy collector devices or other special systems of collection is required. In other cases, it is possible to increase the temperature of the fluid, but is not maintained constant over time. Likewise, other examples of inventions cause variations in the flow rate to achieve said high temperatures. The present invention seeks to achieve these high temperatures (up to 150° C. in the primary circuit), using as a means of solar collection conventional flat or vacuum-tube solar collectors (2), further ensuring a constant temperature and constant flow rates in the primary circuit.

To achieve the objective of the present invention, a solar thermal system is designed, whose peculiarities are in a suitable control and regulation system (6). Said control and regulation system (6) permits, depending on the temperatures and flow rates required at consumption, acting on the primary circuit fundamentally in two aspects: on the one hand, the flow rate through the pump of the primary circuit (4) can be controlled, varying the speed of its engine, and on the other hand, the configuration and arrangement of the battery of solar collectors (2) can be changed, to ensure a suitable outlet temperature of the battery of collectors.

Another feature of the present invention is that all components of the thermal solar installation will meet the standards necessary to work well with temperatures of the heat-transfer fluid up to +180° C.

### BRIEF DESCRIPTION OF THE FIGURES

The accompanying drawing is shown by way of example to improve the understanding of the invention and should not be interpreted restrictively.

FIG. 1.—Shows a diagram of principle of the thermal solar installation, which represents a battery of solar collectors (1), consisting of two or more solar collectors (2), with unlimited units. Also shown are temperature probes, air vents, gate valves and check valves, expansion systems, etc., all of them typical elements of a thermal solar installation.

### REFERENCES

1. Battery of solar collectors
2. Solar collectors
3. 3-way valve
4. Circulation pump
5. Heat exchangers
6. Control system
7. Discharge pipe
8. Return pipe
9. Temperature probe at the outlet of (1)
10. Temperature probe at the outlet of (2)

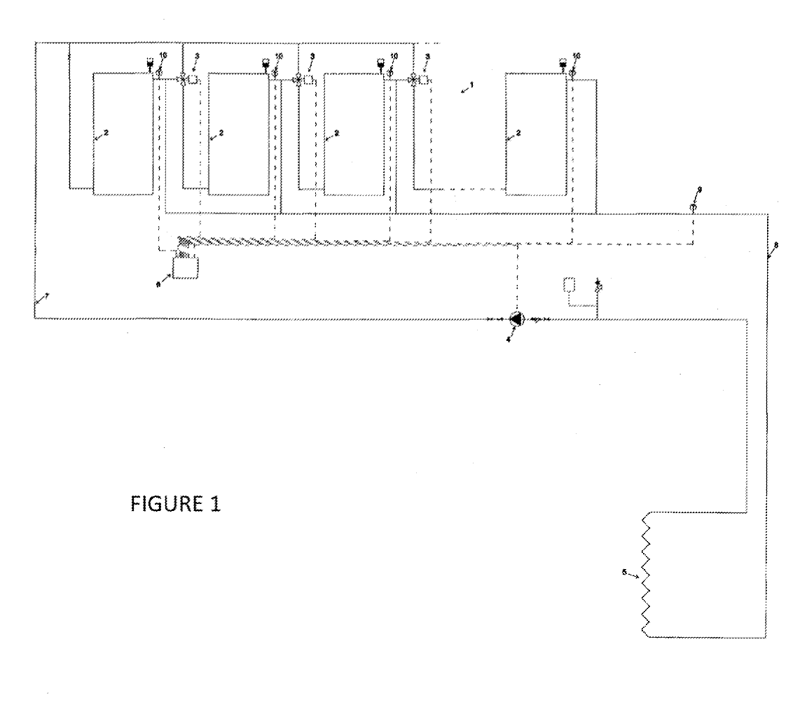

FIG. 1 shows, by the heat-transfer fluid, how the energy captured by the primary circuit is carried and transferred to a consumption circuit or stored in water tanks using heat exchangers (5). To adjust the system, there is a temperature probe (9) at the outlet of the battery of collectors (1) and temperature probes (10) at the outlet of each one of the solar collectors (2). Using a 3-way valve system (3), one or other configuration is allowed in the field of collectors, as needed, in the primary circuit. A circulation pump (4) is responsible for moving the heat-transfer fluid flowing through the battery of collectors (1). A regulation and control system (6) acts on the various elements of the installation to meet the targeted needs. The primary circuit of the solar system ends with a discharge pipe (7) of the heat-transfer fluid, which runs through all the solar collectors (2) and a return pipe (8), which collects the heat-transfer fluid and directs it to consumption.

### Embodiment of the Invention

In order to achieve a better understanding of the purpose of this patent a preferred embodiment is presented.

It is based on a conventional thermal solar installation, to which the necessary changes to ensure adequate versatility in its operation as well as to achieve high and low operating temperatures, as needed, were made. It has a battery of solar collectors (2), these being two or more units, which will always be flat or vacuum-tube solar collectors, never solar concentration system or other kind of special solar collector.

Using a circulation pump (4), the heat-transfer fluid is sent through the discharge pipe (7) to the battery of collectors (1). The solar collectors (2) shall be responsible for transferring energy from the sun to the heat-transfer fluid. Through a return pipe (8) the heated heat-transfer fluid is sent to the consumption circuit by using for the power transfer one or more heat exchangers (5).

A control system (6) shall be responsible for regulating the entire installation. To do so, it will act:

On the 3-way valve system (3) of the battery of collectors (1), to change its configuration, arranging the solar collectors (2) on one configuration or another, depending on the necessary temperature and/or flow rate in the consumption circuit.

On the circulation pump (4), which will be responsible for regulating the flow rate through the battery of collectors (1), depending on the necessary flow rate.

On the other components of the system in its secondary circuit (not developed in the present invention).

The remaining elements of the installation are standard (safety valves, non return valves, filters, temperature probes, pressure gauges, thermometers . . . ).

The system can operate to achieve a setpoint temperature at the outlet of the heat-transfer fluid to move a setpoint flow rate in the primary circuit, or both parameters simultaneously.

In the case of wanting to reach only a setpoint temperature at the outlet of the battery of collectors (1), the system starts its operation by starting the circulation pump (4) with an initial flow rate required. The heat-transfer fluid flows through the primary circuit and into the battery of collectors (1) through the discharge pipe (7), which caters to all solar collectors (2). The valve system (3) is initially arranged so that the collectors (2) have an initial configuration. The heat-transfer fluid is heated by the solar collectors (2) so that when any of the probes (10) placed in the outlet of each solar collector (2) marks the setpoint temperature, the valve system (3) changes the configuration of the solar collectors (2) to direct the heat-transfer fluid to the return pipe (8) of the primary circuit. Thus, the solar collectors (2) necessary to reach said setpoint temperature are used. If the temperature is higher than the setpoint temperature at the outlet of the first solar collector (2) of the battery of collectors (1), the speed of the circulation pump (4) is increased in order to increase the flow rate of the heat-transfer fluid.

When what is desired is to have a constant flow rate in the heat-transfer fluid, the control system (6) acts on the circulation pump (4) to adjust the speed of it and move the required flow rate.

In the case of needing a constant flow rate and temperature at the outlet of the battery of collectors (1), such as, for example, refrigeration/absorption chilling installations, the control system (6) acts on the valve system (3) and on the circulation pump (4). For this, the control system (6) sets a constant flow rate acting on the speed of the circulation pump (4), while acting on the valve system (3) for arranging the battery of collectors (1) at one or other configuration, according to the temperatures marked by the outlet probes (10) of each solar collector (2) and by the temperature probe (9) located in the return pipe (8) of the primary circuit. This will ensure a constant flow rate and temperature at all times at the outlet of the battery of collectors (1).

This configuration allows achieving a wide range of temperatures at the outlet of the battery of collectors (1), from +40° C. to +150° C.

The hot water can be used directly by a consumption circuit (preferably industrial application, domestic hot water production, heating, absorption chilling), transferring the energy through heat exchangers (5).

Depending on its use, time and season, providing a certain percentage of an auxiliary power source will be necessary, which will depend on the number of solar collectors (2) installed.

With the present invention the annual percentage of said auxiliary energy that will be necessary to be provided is determined a priori, and compared with the cost of the installation, the investment can be optimized.

All components of the thermal solar installation are characterized in that they will meet the standards necessary to work well with temperatures of the heat-transfer fluid up to 180° C.

1. Versatile thermal solar system for producing hot water up to high temperatures, based on a thermal solar installation comprising a battery (1) of two or more solar collectors (2) without limit of units, valve system (3), circulation pump (4), heat exchanger of consumption circuit (5), control system (6), heat-transfer fluid discharge pipe (7), heat-transfer fluid return pipe (8), temperature probe (9) at the outlet of the return pipe (8), temperature probe (10) at the outlet of each solar collector (2), wherein said versatility allows the system achieving operating temperatures in the primary circuit between +40° C. and +150° C.

2. Versatile thermal solar system for producing hot water up to high temperatures, according to claim 1, wherein said working temperatures are achieved while maintaining some values of temperature, flow rate or both simultaneously in the heat-transfer fluid at the outlet of the battery of solar collectors (2), which allows the use of solar energy in all types of industrial systems, heating, domestic hot water heating and absorption chilling.

3. Versatile thermal solar system for producing hot water up to high temperatures, according to claim 1, wherein the battery of solar collectors (2) comprises flat or vacuum-tube solar collectors (2), and wherein concentration systems of solar radiation or other kind of special solar collector are not used.

4. Versatile thermal solar system for producing hot water up to high temperatures, according to claim 1, comprising at least two solar collectors (2) and wherein the number of said solar collectors (2) varies according to the size and requirements of the installation, with no limit in the number of units.

5. Versatile thermal solar system for producing hot water up to high temperatures, according to claim 1, wherein the control system (6) is responsible for obtaining said versatility, acting on the configuration of the battery of collectors (1), as well as on the speed of the circulation pump of the primary circuit (4) to thus achieve regulating the flow rate and temperature available and needed in the consumption circuit.

6. Versatile thermal solar system for producing hot water up to high temperatures, according to claim 1, wherein all the components of the installation meet the necessary standards to work properly at temperatures of the heat-transfer fluid up to 180° C.

7. Versatile thermal solar system for producing hot water up to high temperatures, according to claim 1, comprising an auxiliary power source to meet the consumption requirements of the heat-transfer fluid, a priori, and wherein the annual percentage of said auxiliary power that needs to be provided can be determined according to the number of solar collectors (2) of the system, and comparing it to the total cost of the installation, the profitability of the investment can be determined.

8. Versatile thermal solar system for producing hot water up to high temperatures, according to claim 1, allowing generating fluid at temperatures above 100° C., which in turn allows producing steam with the resulting application for electricity production.

9. Versatile thermal solar system for producing hot water up to high temperatures, according to claim 2, wherein the battery of solar collectors (2) comprises flat or vacuum-tube solar collectors (2), and wherein concentration systems of solar radiation or other kind of special solar collector are not used.

10. Versatile thermal solar system for producing hot water up to high temperatures, according to claim 2, comprising at least two solar collectors (2) and wherein the number of said solar collectors (2) varies according to the size and requirements of the installation, with no limit in the number of units.

11. Versatile thermal solar system for producing hot water up to high temperatures, according to claim 3, comprising at least two solar collectors (2) and wherein the number of said solar collectors (2) varies according to the size and requirements of the installation, with no limit in the number of units.

12. Versatile thermal solar system for producing hot water up to high temperatures, according to claim 2, wherein the control system (6) is responsible for obtaining said versatility, acting on the configuration of the battery of collectors (1), as well as on the speed of the circulation pump of the primary circuit (4) to thus achieve regulating the flow rate and temperature available and needed in the consumption circuit.

13. Versatile thermal solar system for producing hot water up to high temperatures, according to claim 2, wherein all the components of the installation meet the necessary standards to work properly at temperatures of the heat-transfer fluid up to 180° C.

14. Versatile thermal solar system for producing hot water up to high temperatures, according to claim 3, wherein all the components of the installation meet the necessary standards to work properly at temperatures of the heat-transfer fluid up to 180° C.

15. Versatile thermal solar system for producing hot water up to high temperatures, according to claim 4, wherein all the components of the installation meet the necessary standards to work properly at temperatures of the heat-transfer fluid up to 180° C.

16. Versatile thermal solar system for producing hot water up to high temperatures, according to claim 5, wherein all the components of the installation meet the necessary standards to work properly at temperatures of the heat-transfer fluid up to 180° C.

17. Versatile thermal solar system for producing hot water up to high temperatures, according to claim 2, allowing generating fluid at temperatures above 100° C., which in turn allows producing steam with the resulting application for electricity production.

18. Versatile thermal solar system for producing hot water up to high temperatures, according to claim 3, allowing generating fluid at temperatures above 100° C., which in turn allows producing steam with the resulting application for electricity production.

19. Versatile thermal solar system for producing hot water up to high temperatures, according to claim 4, allowing generating fluid at temperatures above 100° C., which in turn allows producing steam with the resulting application for electricity production.

20. Versatile thermal solar system for producing hot water up to high temperatures, according to claim 5, allowing generating fluid at temperatures above 100° C., which in turn allows producing steam with the resulting application for electricity production.

21. Versatile thermal solar system for producing hot water up to high temperatures, according to claim 6, allowing generating fluid at temperatures above 100° C., which in turn allows producing steam with the resulting application for electricity production.

22. Versatile thermal solar system for producing hot water up to high temperatures, according to claim 7, allowing generating fluid at temperatures above 100° C., which in turn allows producing steam with the resulting application for electricity production.
